(19) United States
(12) Patent Application Publication
(10) Pub. No.: US 2004/0089732 A1
(43) Pub. Date: May 13, 2004

(54) Common rail for accumulation type fuel injection system

(75) Inventor: Shigeru Nonoyama, Nishikamo-gun (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Aichi-pref (JP)

(21) Appl. No.: 10/695,354

(22) Filed: Oct. 29, 2003

(30) Foreign Application Priority Data
Oct. 29, 2002 (JP) 2002-314812

(51) Int. Cl. F02M 47/02; F02M 41/16

(52) U.S. Cl. 239/88; 239/96

(57) ABSTRACT

A common rail for an accumulation type fuel injection system is formed of a plurality of pipe connectors in the form of a cross or a tee and a connecting pipe for connecting the pipe connectors with each other. Respective ends of the pipe connector provide pipe connecting portions, to which a pump pipe and injector pipes are connected, and another pipe connecting portion, to which the connecting pipe is connected. Insides of the pipe connectors and the connecting pipe provide a volume portion for accumulating high-pressure fuel. Thus, conventionally required welding technology is not required. Therefore, production cost of the common rail is reduced. Meanwhile, the size of the common rail is reduced and the common rail is mounted to a vehicle more easily.

### CROSS REFERENCE TO RELATED APPLICATION

This application is based on and incorporates herein by reference Japanese Patent Application No. 2002-314812 filed on Oct. 29, 2002.

### BACKGROUND OF THE INVENTION

1. Field of the Invention:

The present invention relates to a common rail for accumulating high-pressure fuel in an accumulation type fuel injection system.

2. Description of Related Art:

As shown in FIG. 8, a conventional common rail 1 is formed of a cylindrical high-pressure vessel 1A, which is formed with pipe connecting portions (small diameter screw portions) 1B and functional component connecting portions (large diameter screw portions) 1C. A pump pipe 6 and injector pipes 7 are connected to the pipe connecting portions 1B respectively. Functional components such as a pressure limiter 10, a pressure reducing valve 11, a pressure sensor (Pc sensor) 15 and the like are connected to the functional component connecting portions 1C.

The common rail 1 is required to be highly pressure-tight. Therefore, sophisticated processing technology and high-pressure sealing technology are required to produce the common rail 1. As a result, the cost of the common rail 1 is increased.

Therefore, these days, the high-pressure vessel 1A of the common rail 1 is formed of an inexpensive pipe member. The pipe member is formed with a plurality of holes disposed along the direction of the axis. Then, the pipe connecting portions 1B are welded to rims of the holes respectively. Thus, the cost of the common rail 1 is reduced.

However, since the common rail 1 formed of the inexpensive pipe member is produced by welding the plurality of pipe connecting portions 1B to the pipe member along the axial direction, physical size of the common rail 1 is increased. In addition, since many portions need to be welded, the cost reduction is difficult.

### SUMMARY OF THE INVENTION

It is therefore an object of the present invention to provide an accumulation type fuel injection system capable of reducing cost and size of a common rail.

According to an aspect of the present invention, a common rail of an accumulation type fuel injection system is formed of a plurality of pipe connectors in the shape of a tee, a wye or a cross and at least one connecting pipe for connecting the plurality of pipe connectors with each other. Ends of each pipe connector are formed with pipe connecting portions connected with a pump pipe and injector pipes and are formed with another pipe connecting portion connected with the connecting pipe. A volume portion is formed inside the plurality of pipe connectors and the connecting pipe.

Thus, a welding process for attaching the pipe connecting portions to the common rail is not required, so production cost of the common rail can be reduced.

The common rail is not formed in the shape of a pipe, unlike a conventional common rail. Instead, the common rail is formed of the plurality of pipe connectors in the shape of a tee, a wye or a cross and the connecting pipe for connecting the plurality of pipe connectors with each other. Therefore, the size of the common rail can be reduced, compared to the conventional common rail.

### BRIEF DESCRIPTION OF THE DRAWINGS

Features and advantages of embodiments will be appreciated, as well as methods of operation and the function of the related parts, from a study of the following detailed description, the appended claims, and the drawings, all of which form a part of this application. In the drawings:

FIG. 1 is a schematic diagram showing a common rail for a four-cylinder engine according to a first embodiment of the present invention;

FIG. 2 is a schematic diagram showing a common rail for a six-cylinder engine according to a second embodiment of the present invention;

FIG. 3 is a schematic diagram showing a common rail formed of a plurality of pipe connectors alone according to a third embodiment of the present invention;

FIG. 4 is a schematic diagram showing a common rail formed of a single pipe connector alone according to a fourth embodiment of the present invention;

FIG. 5A is a schematic diagram showing a method of mounting a common rail to an engine according to a fifth embodiment of the present invention;

FIG. 5B is a schematic diagram showing another method of mounting the common rail to the engine according to the fifth embodiment of the present invention;

FIG. 5C is a schematic diagram showing another method of mounting the common rail to the engine according to the fifth embodiment of the present invention;

FIG. 5D is a schematic diagram showing yet another method of mounting the common rail to the engine according to the fifth embodiment of the present invention;

FIG. 6A is a schematic diagram showing a common rail, to which a functional component is connected, according to a sixth embodiment of the present invention;

FIG. 6B is a schematic diagram showing the common rail, to which the functional components are connected, according to the sixth embodiment of the present invention;

FIG. 7 is a schematic diagram showing a common rail formed with orifices inside according to a seventh embodiment of the present invention; and

FIG. 8 is a diagram showing an accumulation type fuel injection system having a common rail of a conventional technology.

### DETAILED DESCRIPTION OF THE REFERRED EMBODIMENTS

(First Embodiment)

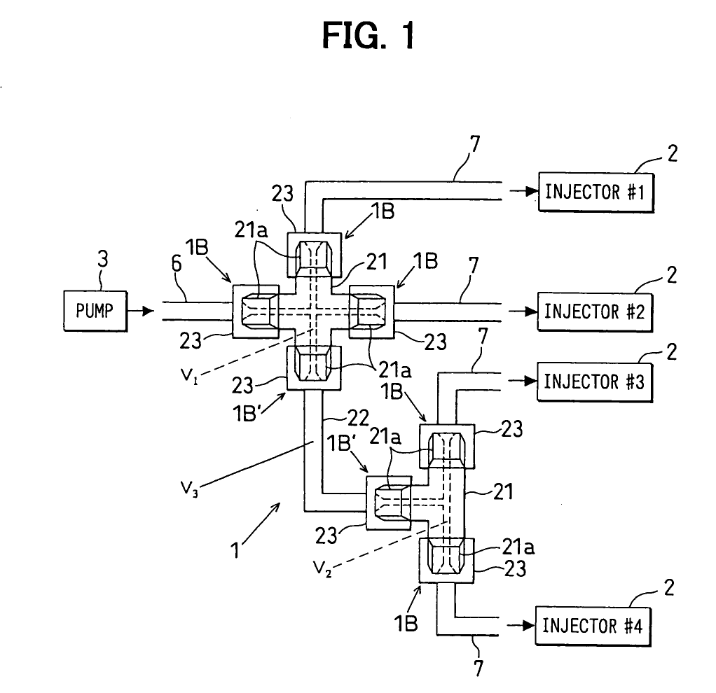

Referring to FIG. 1, a common rail 1 according to the first embodiment of the present invention is illustrated.

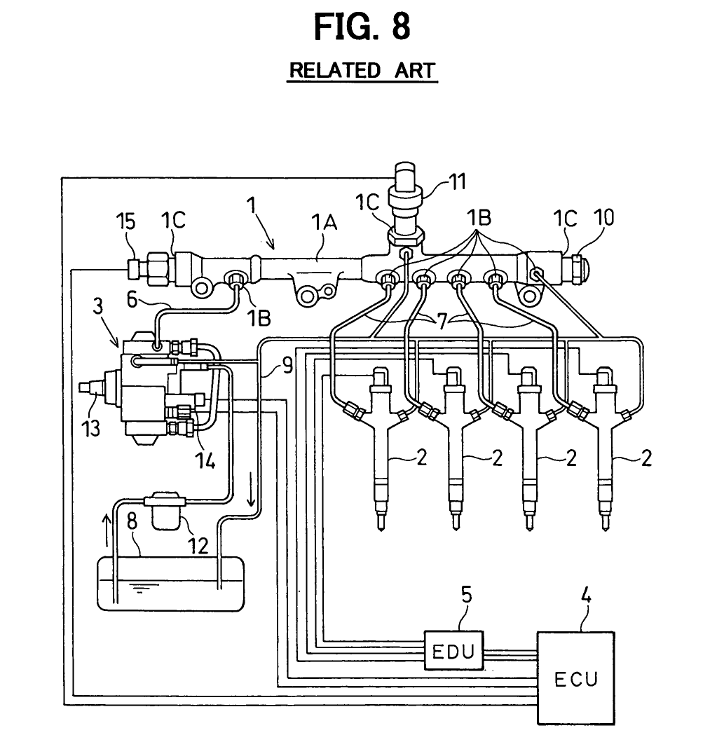

First, system structure of an accumulation type fuel injection system having a conventional common rail 1 is explained based on FIG. 8. Then, the common rail 1 of the present embodiment is explained based on FIG. 1.

The accumulation type fuel injection system shown in FIG. 8 performs fuel injection into a four-cylinder engine such as a diesel engine. The accumulation type fuel injection system has the common rail 1, injectors 2, a supply pump 3, an electronic control unit (ECU) 4, an electronic driving unit (EDU) 5 and the like.

The common rail 1 is an accumulation vessel for accumulating high-pressure fuel supplied to the injectors 2. In order to accumulate common rail pressure corresponding to fuel injection pressure, the common rail 1 is connected with a discharge hole of the supply pump 3 through a pump pipe 6. The supply pump 3 pressure-feeds the high-pressure fuel. The common rail 1 is also connected with a plurality of injector pipes 7 for introducing the high-pressure fuel to the respective injectors 2.

A pressure limiter 10 is disposed in a high-pressure vessel 1A for returning the fuel from the common rail 1 to a fuel tank 8. The pressure limiter 10 is a pressure safety valve, which opens when the common rail pressure exceeds limit set pressure in order to control the common rail pressure under the limit set pressure.

A pressure reducing valve 11 is mounted to the common rail 1. The pressure reducing valve 11 opens if a valve-opening command signal is supplied by the ECU 4. Thus, the pressure reducing valve 11 quickly reduces the common rail pressure with the use of the relief pipe 9. Thus, the ECU 4 can control and decrease the common rail pressure to a pressure corresponding to a traveling state of a vehicle with the pressure reducing valve 11 mounted to the common rail 1.

The injector 2 is mounted in each cylinder of the engine for injecting the fuel into the cylinder. The injector 2 has a fuel injection nozzle, an electromagnetic valve and the like. The fuel injection nozzle is connected to a downstream end of one of the injector pipes 7 branching from the common rail 1 and injects the high-pressure fuel accumulated in the common rail 1 into the cylinder. The electromagnetic valve controls a lifting distance of a needle accommodated in the fuel injection nozzle.

Leak fuel from the injectors 2 is also returned to the fuel tank 8 through the relief pipe 9.

The supply pump 3 is a high-pressure fuel pump for pressure-feeding the high-pressure fuel to the common rail 1. The supply pump 3 has a feed pump for drawing the fuel from the fuel tank 8 to the supply pump 3 through a filter 12. The supply pump 3 pressurizes the drawn fuel to a high pressure and pressure-feeds the high-pressure fuel into the common rail 1. A common camshaft 13 drives the supply pump 3 and the feed pump. The engine drives the camshaft 13 to rotate.

The supply pump 3 has a suction control valve (SCV) 14 in a fuel passage for introducing the fuel into a pressurizing chamber, in which the fuel is pressurized to a high pressure. The SCV 14 regulates an opening degree of the fuel passage. The SCV 14 is controlled by a pump driving signal outputted from the ECU 4 to regulate the quantity of the fuel drawn into the pressurizing chamber and to vary the quantity of the fuel pressure-fed to the common rail 1. Thus, the SCV 14 regulates the common rail pressure. More specifically, the ECU 4 can control the common rail pressure in accordance with the traveling state of the vehicle by controlling the SCV 14.

The ECU 4 has CPU, RAM, ROM and the like. The ECU 4 performs various types of calculation processing based on programs stored in the ROM and sensor signals (an operating state of the vehicle) inputted to the RAM.

For instance, the ECU 4 determines target injection quantity, an injection mode and valve opening timing of the injector 2 for each fuel injection at each cylinder based on the programs stored in the ROM and the sensor signals inputted to the RAM.

The EDU 5 is a driving circuit for supplying valve opening driving current to the electromagnetic valve of the injector 2 based on an injector valve opening signal supplied by the ECU 4. If the EDU 5 supplies the valve opening driving current to the electromagnetic valve, the high-pressure fuel is supplied into the cylinder. If the valve opening driving current is turned off, the fuel injection is stopped.

The ECU 4 is connected with sensors as means for detecting the operating state of the vehicle such as an accelerator position sensor for sensing an accelerator position, a rotation speed sensor for sensing an engine rotation speed, a water temperature sensor for sensing temperature of cooling water of the engine and the like, in addition to a pressure sensor 15 for sensing the common rail pressure.

The conventional common rail 1 is made of the cylindrical high-pressure vessel 1A formed with pipe connecting portions 1B and functional component connecting portions 1C. The pump pipe 6, the injector pipes 7 and the like are connected to the pipe connecting portions 1B. The functional components such as the pressure limiter 10, the pressure reducing valve 11, the pressure sensor 15 and the like are connected to the functional component connecting portions 1C. In order to achieve high pressure-tightness, sophisticated processing technology and high-pressure sealing technology are required. As a result, production cost of the common rail 1 is increased.

Therefore, the high-pressure vessel 1A of the common rail 1 is formed of an inexpensive pipe member, and the plurality of pipe connecting portions 1B is welded to the high-pressure vessel 1A along an axial direction of the pipe member in order to reduce the cost. However, since the plurality of the pipe connecting portions 1B needs to be welded, cost reduction is difficult. In addition, since the pipe member is long in the axial direction, physical size of the common rail 1 is increased.

In order to solve the above problems, the common rail 1 of the first embodiment is formed as shown in FIG. 1. The common rail 1 has a plurality of pipe connectors 21 in the shape of a cross or a tee and a connecting pipe 22 for connecting the plurality of pipe connectors 21 with each other. The pipe connector 21 is formed with pipe connecting portions 1B, 1B′ at its ends. The pump pipe 6 and the injector pipes 7 for the four cylinders are connected to the pipe connecting portions 1B respectively. The pipe connector 21 is connected with the connecting pipe 22 at the pipe connecting portion 1B′. The pipe connecting portions 1B, 1B′ are formed in the same shape. Alternatively, the pipe connecting portions 1B, 1B′ may be formed in different shapes. Insides of the respective pipe connectors 21 having volume of V1, V2 and an inside of the connecting pipe 22 having volume of V3, through which the fuel flows, form a volume portion for accumulating the high-pressure fuel.

The pipe connectors 21 are formed of metal such as iron, brass, cupper, aluminum and the like. The connecting pipe 22 is a metallic pipe made of the brass, the cupper or the aluminum, which is easy to process. Alternatively, the connecting pipe 22 may be formed of highly pressure-tight fiber reinforced resin.

Male screws 21a in the same shape are formed around the respective pipe connecting portions 1B, 1B′. A female screw member 23 is attached to an end of the metallic pipe (the pump pipe 6, the injector pipe 7 or the connecting pipe 22), whose tip is shaped in a bulging process. The female screw member 23 attached to the end of the metallic pipe is strongly screwed to the male screw 21a of one of the pipe connecting portions 1B, 1B′. Thus, the connection of the pipe connecting portions 1B, 1B′ is achieved. The method for connecting the pipe connecting portions 1B, 1B′ with the metallic pipe (the pump pipe 6, the injector pipe 7 or the connecting pipe 22) is not limited to the above method. Other known methods for connecting high-pressure portions, for instance, a connecting method using an O-ring as a sealing member, may be employed.

The conventionally required welding technology is not required in the structure of the common rail 1 shown in FIG. 1. Therefore, the production cost of the common rail 1 can be reduced.

The common rail 1 is not formed in the shape of a pipe, unlike the conventional common rail, but is formed of the pipe connectors 21, which are formed in the shape of a cross or a tee, and the connecting pipe 22. Therefore, the size of the common rail 1 can be reduced, and the common rail 1 can be mounted to the vehicle more easily.

(Second Embodiment)

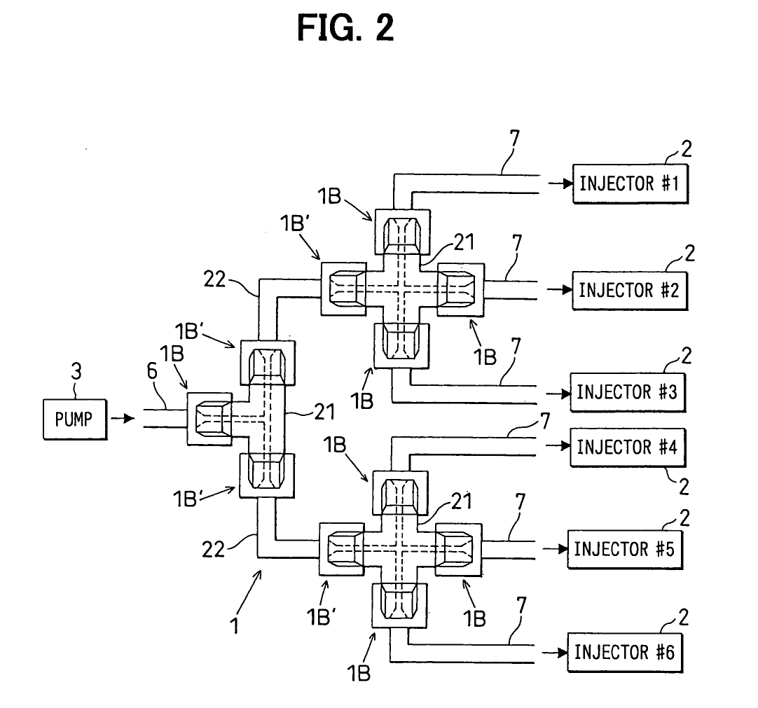

Next, a common rail 1 according to the second embodiment of the present invention will be explained based on FIG. 2.

The common rail 1 of the second embodiment is used for a six-cylinder engine. Therefore, another pipe connector 21 and another connecting pipe 22 are added, so the number of the pipe connecting portions 1B, 1B′ is increased.

Thus, the common rail 1 can be applied to an engine having any number of the cylinders by changing the numbers of the pipe connectors 21 and the connecting pipes 22.

(Third Embodiment)

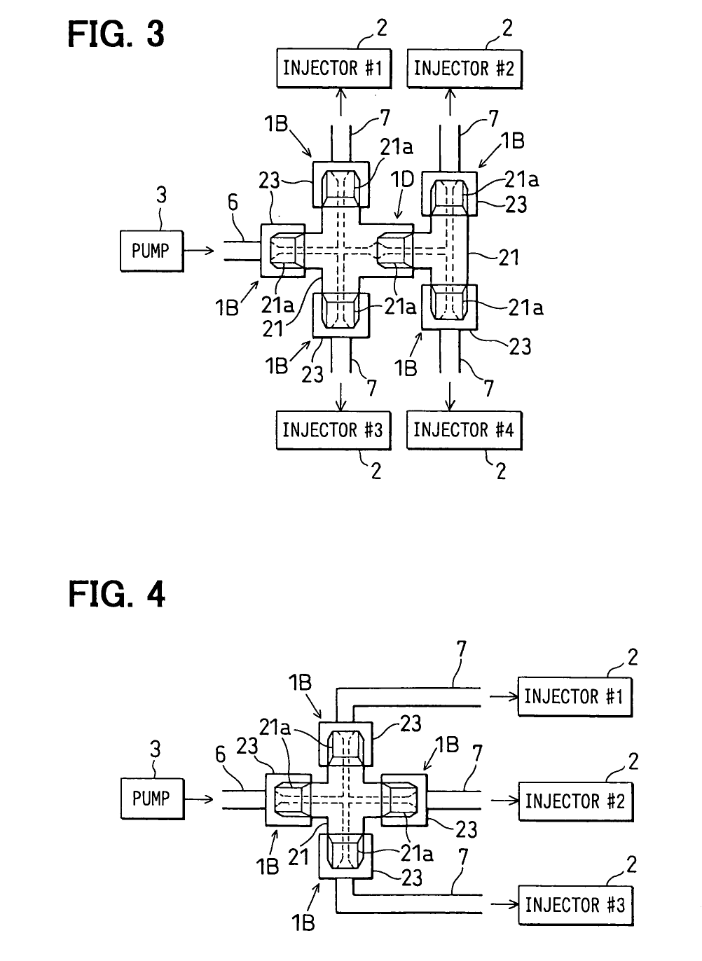

Next, a common rail 1 according to the third embodiment of the present invention will be explained based on FIG. 3. The common rail 1 of the third embodiment has no connecting pipe 22, but is formed of the pipe connectors 21 alone.

As shown in FIG. 3, the common rail 1 is formed by connecting the two pipe connectors 21 with each other at a connecting portion 1D.

Thus, the common rail 1 can be applied to an engine having any number of the cylinders by changing the number of the pipe connectors 21.

The shape (a diameter, a screw thread pitch or the like) of the connecting portion 1D at which the pipe connectors 21 are connected with each other may be formed in the same shape as the functional component connecting portion 1C.

(Fourth Embodiment)

Next, a common rail 1 according to the fourth embodiment of the present invention will be explained based on FIG. 4. The common rail 1 of the fourth embodiment is formed of a single pipe connector 21 alone.

The common rail 1, which is formed of the single pipe connector 21 alone as shown in FIG. 4, can be applied to an engine having three or less injectors 2.

(Fifth Embodiment)

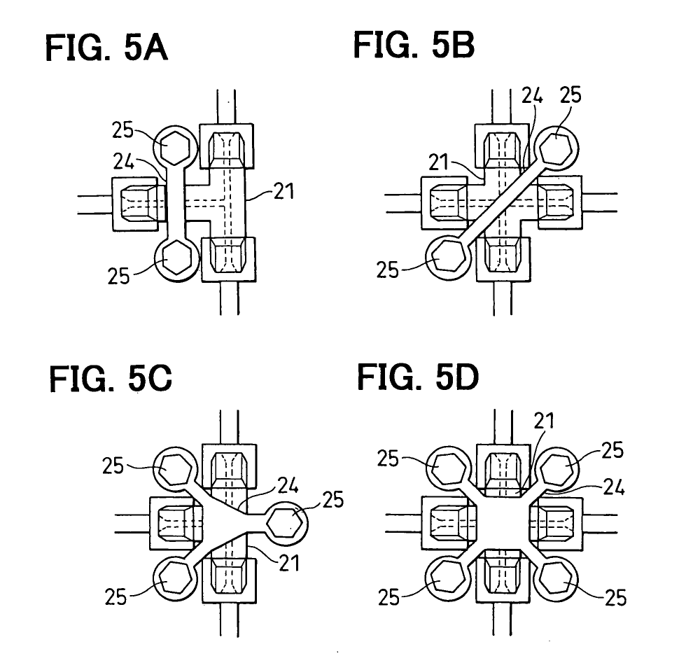

Next, a common rail 1 according to the fifth embodiment of the present invention will be explained based on FIGS. 5A, 5B, 5C and 5D. The common rail 1 of the fifth embodiment is mounted to the vehicle by fixing the pipe connector 21 to the engine with a stay 24.

The stay 24 is a metallic member fixed to the engine with a fixing member 25 such as a bolt in a state in which the stay 24 covers at least a part of the pipe connector 21.

The stay 24 may cover only a rod-like portion of the pipe connector 21 as shown in FIG. 5A, or may cover a branching portion of the pipe connector 21 as shown in FIG. 5B, 5C or 5D. In the latter case, the stay 24 in the shape of a wye or a cross may be employed as shown in FIG. 5C or 5D.

Thus, the common rail 1 is mounted to the engine by fixing the pipe connector 21 to the engine with the stay 24.

(Sixth Embodiment)

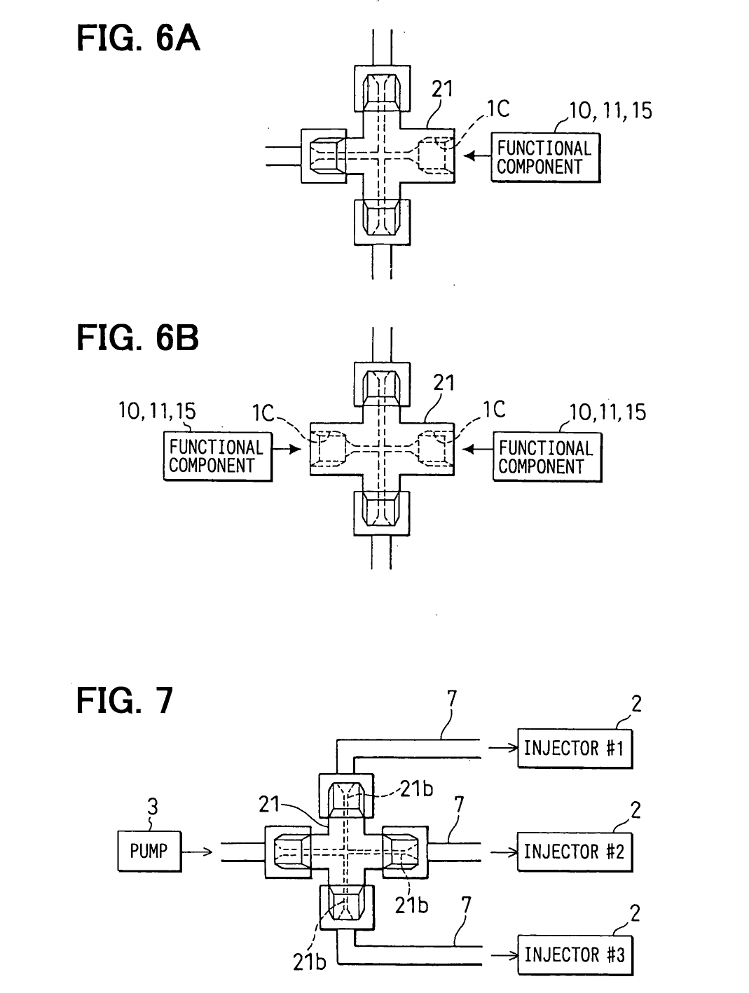

Next, a common rail 1 according to the sixth embodiment of the present invention will be explained based on FIGS. 6A and 6B. In the case where the functional component such as the pressure limiter 10, the pressure reducing valve 11 or the pressure sensor 15 is connected to the common rail 1, the functional component connecting portion 1C is formed in at least one of the ends of the pipe connector 21 as shown in FIGS. 6A and 6B. Then, the functional component is connected to the functional component connecting portion 1C.

Thus, the functional components such as the pressure limiter 10, the pressure reducing valve 11 or the pressure sensor 15 can be connected to the common rail 1 easily.

(Seventh Embodiment)

Next, a common rail 1 according to the seventh embodiment of the present invention will be explained based on FIG. 7.

As shown in FIG. 7, an internal diameter of a hole inside the pipe connecting portion 1B connected with the injector pipe 7 is reduced, compared to the holes inside the other pipe connecting portions 1B. Thus, an orifice 21b is formed at the hole inside the pipe connecting portion 1B connected with the injector pipe 7.

Thus, pressure pulsation generated in the injector pipe 7 can be reduced by the orifice 21b formed inside the pipe connecting portion 1B.

(Modification)

The connecting pipe 22 may be lengthened by winding the connecting pipe 22 into a spiral shape or by zigzagging the connecting pipe 22. Thus, the volume of the common rail 1 is increased easily by lengthening the connecting pipe 22. More specifically, the volume of the common rail 1 can be modified easily by changing the length of the connecting pipe 22.

The present invention should not be limited to the disclosed embodiments, but may be implemented in many other ways without departing from the spirit of the invention.

What is claimed is:

1. An accumulation type fuel injection system, comprising:
a common rail having pipe connecting portions, to which a pump pipe for introducing high-pressure fuel from a supply pump to the common rail and injector pipes for introducing the high-pressure fuel to injectors are connected, and a volume portion formed inside the common rail for accumulating the high-pressure fuel, wherein
the common rail is formed of pipe connecting means in the shape of a tee, a wye or a cross, and
the pipe connecting means is formed with the pipe connecting portions at ends thereof and is formed with a hole for providing the volume portion on an inside thereof.

2. The accumulation type fuel injection system as in claim 1, wherein the pipe connecting means is a single pipe connector in the shape of a tee, a wye or a cross.

3. The accumulation type fuel injection system as in claim 1, wherein the pipe connecting means includes a plurality of pipe connectors in the shape of a tee, a wye or a cross.

4. The accumulation type fuel injection system as in claim 3, wherein the pipe connector is formed with another pipe connecting portion at and end thereof for connecting the plurality of pipe connectors with each other.

5. The accumulation type fuel injection system as in claim 3, further comprising:
at least one connecting pipe for connecting the plurality of pipe connectors with each other and for providing the volume portion on an inside thereof, wherein
the connecting pipe is included in the common rail, and
the pipe connector is formed with another pipe connecting portion at an end thereof, at which the pipe connector is connected with the connecting pipe.

6. The accumulation type fuel injection system as in claim 1, wherein the common rail is mounted to an engine by fixing the pipe connecting means to the engine with a stay.

7. The accumulation type fuel injection system as in claim 1, wherein the pipe connecting means is formed with a functional component connecting portion at the end thereof, at which a functional component is connected to the pipe connecting means.

8. The accumulation type fuel injection system as in claim 7, wherein the functional component is a pressure sensor, a pressure limiter or a pressure reducing valve.

9. The accumulation type fuel injection system as in claim 1, wherein the hole formed inside the pipe connecting means connected with the injector pipe provides an orifice.
